(19) United States
(12) Patent Application Publication
(10) Pub. No.: US 2026/0148528 A1
(43) Pub. Date: May 28, 2026

(54) DATA AUGMENTATION METHOD AND SYSTEM

(71) Applicant: INDUSTRIAL TECHNOLOGY RESEARCH INSTITUTE, HSINCHU (TW)

(72) Inventors: Chih-Neng LIU, Tainan City (TW); Ming-Yu SHIH, Taoyuan City (TW)

(21) Appl. No.: 18/991,680

(22) Filed: Dec. 22, 2024

(30) Foreign Application Priority Data
Nov. 25, 2024 (TW) 113145410

(51) Int. Cl. G06V 10/774; G06T 11/00

(52) U.S. Cl. CPC G06V 10/774; G06T 11/00; G06T 2210/22

(57) ABSTRACT

A data augmentation method includes: obtaining first field images captured in a first field and second field images captured in a second field; cropping first object images and second object images respectively from the first field images and the second field images; training an object generation model by the first object images and the second object images; generating new object images by the object generation model; synthesizing the new object images into the second field images as new object field images; and training an object discrimination model with the second field images and the new object field images.

### RELATED APPLICATIONS

The present application is based on, and claims priority from, Taiwan Application Serial Number 113145410, filed Nov. 25, 2024, the disclosure of which is hereby incorporated by reference herein in its entirety.

### BACKGROUND

### Technical Field

The technical field relates to a data augmentation method and system.

### Description of Related Art

Model training generally requires a large number of data to obtain sufficiently accurate classification or prediction results. However, collecting a large number of data is time-consuming and laborious. When there is an urgent need to analyze the production line with artificial intelligence, it is difficult to wait until the number of data is sufficient for training and introducing artificial intelligence into practical applications. In addition, even if a large number of old data collected in the past is used for current model training, the features in the old data usually cannot meet the needs of the current new situation, and therefore cannot be used directly, and there is still a need to collect a large number of new data. Accordingly, how to obtain a large number of training data in a short period of time that can be used to train models that adapt to new situations is an important issue that needs to be solved.

### SUMMARY

The disclosure provides a data augmentation method. The data augmentation method includes: obtaining first field images captured in a first field and second field images captured in a second field, in which a number of the first field images is greater than a number of the second field images; cropping first object images and second object images respectively from the first field images and the second field images; training an object generation model with the first object images and the second object images; generating new object images by the object generation model; synthesizing the new object images into the second field images as new object field images; and training an object discrimination model with the second field images and the new object field images.

The disclosure provides a data augmentation system. The data augmentation system includes: an image database, a first image processing server, a second image processing server, and an object discrimination server. The image database is for storing first field images captured in a first field and second field images captured in a second field, in which a number of the first field images is greater than a number of the second field images. The first image processing server receives the first field images and the second field images from the image database, and includes an image cropping module, configured to crop first object images and second object images respectively from the first field images and the second field images. The data augmentation server is for receiving the first object images and the second object images from the first image processing server, and includes an object generation module, u configured to train an object generation model with the first object images and the second object images, and generating new object images by the object generation model. The second image processing server is for receiving the new object images from the data augmentation server, and includes an image synthesis module, configured to synthesize the new object images into the second field image as new object field images. The object discrimination server is for training an object discrimination model with the second field images and the new object field images.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a data augmentation system in accordance with some embodiments of the present disclosure.

FIG. 2 is a flowchart of a data augmentation method in accordance with some embodiments of the present disclosure.

FIG. 3 is a schematic diagram of processing the images with a data augmentation method in accordance with some embodiments of the present disclosure.

### DETAILED DESCRIPTION

The following exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

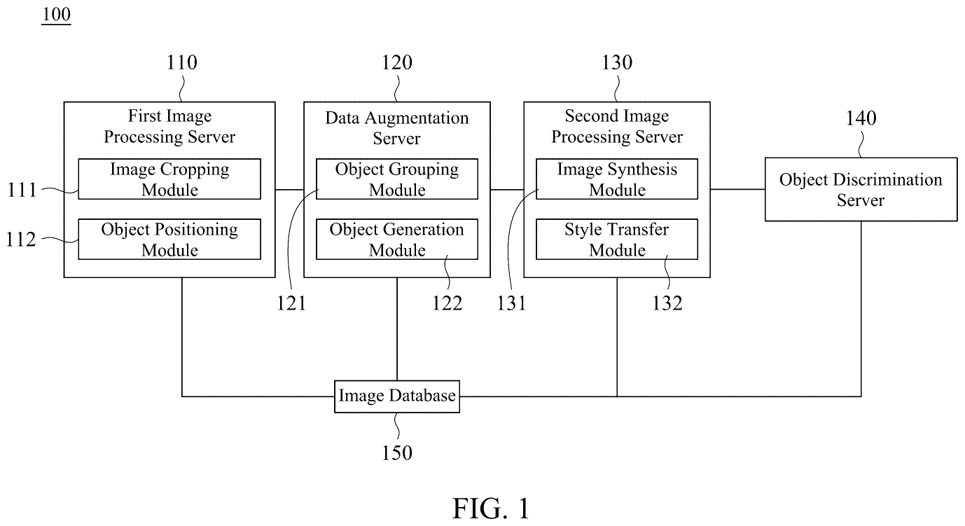

FIG. 1 is a schematic diagram of a data augmentation system 100 in accordance with some embodiments of the present disclosure. In one embodiment, the data augmentation system 100 includes: a first image processing server 110, a data augmentation server 120, a second image processing server 130, an object discrimination server 140, and an image database 150. The first image processing server 110 is connected to the data augmentation server 120, the second image processing server 130 is connected to the data augmentation server 120, the object discrimination server 140 is connected to the second image processing server 130, and the first image processing server 110, the data augmentation server 120, the second image processing server 130, and the object discrimination server 140 are connected to the image database 150. The first image processing server 110 includes an image cropping module 111 and an object positioning module 112. The data augmentation server 120 includes an object grouping module 121 and the object generation module 122. The second image processing server 130 includes image synthesis module 131 and a style transfer module 132.

In one embodiment, the image database 150 stores first field images and second field images. The first field images may be a large number of image data captured in a first field over a long period of time, or may be used for training models related to the first field in the past. The second field images are taken or collected in another field that is different from the first field, which may be a completely different field, a field with the same configuration but different light tones, or a field with the same location but different decoration configuration. The difference between the first field and the second field is not limited thereto.

However, the first field and the second field include the same detection object target. For example, when the object target detected is whether workers are wearing safety helmets, both the first field images and the second field include workers with/without safety helmets, or when the object target is whether vehicles are equipped with snow chains, both the first field images and the second field images include vehicles with/without snow chains. In addition, in the embodiment, the second field is a field that is started to be paid attention to later or is newly built, so the number of the second field images is smaller than the first field images.

After receiving the first field images and the second field images from the image database 150, the first image processing server 110, crops the object targets in the first field images and the second field images by the image cropping module 111. The way to crop the object cropping is using an object detection model to detect the object targets in the first field images and the second field images and crop them out. The object detection model and the way of cropping are not limited thereto as long as it may be used for selecting and cropping the specific target, for example, human or item, from the first field image and the second field image according to the instructions.

In addition, the first image processing server 110 is used for cropping the target object, and may also be used for positioning the target objects in the second field images by the object positioning module 112. In the way of positioning, the object position information such as the X and Y positioning coordinates of the target objects in the second field images may be obtained by the object detection model or any method, and used as a position reference for synthesis when the image synthesis module 131 synthesizing the image subsequently.

After cropping the target objects, the first object images and the second object images cropped from the first field images and the second field images are obtained. Because these object images correspond to different status of objects, these object images may be grouped by the object grouping module 121. The way to group objects may be to manually label the groups or to group by common image classification models, such as convolution neural network (CNN). After grouping, the object images are not grouped into the first object images and the second object images as original, but grouped into different groups according to the status of the objects in the object images, such as whether workers are wearing safety helmets, or whether vehicles are equipped with snow chains. Then, the object generation module 122 may be used for training the object generation models corresponding to each group with the object images of each group.

The object generation model is trained with the object images of each group and used for generating new object images corresponding to each group. The object generation model may be a text-to-image generative AI model, such as the Stable Diffusion Low-Rank Adaptation (Stable Diffusion LoRA) model and Stable Diffusion XL Low-Rank Adaptation (Stable Diffusion XL LoRA) model based on stable diffusion image generation technology, which generates images that meet the needs based on the images and text descriptions in the training data. Therefore, in the embodiment, the grouped object images are used with text instructions, such as description text used for describing the image to be generated, to generate new object images that match the groups. Because the generative AI model may be trained with text and images at the same time, in another embodiment, grouping the object images by the object grouping module 121 and entering the relevant text manually may not be performed. Instead, the description text corresponding to the first object images and/or the second object images may be directly generated with an image-to-text generative AI model as text instructions. The object images and the text instructions are used as model input to train the object generation model so that the object generation model generates new object images that meet the needs.

After the object generation module 122 generates new object images of each group, the second image processing server 130 synthesizes these new object images with the second field images, and when the second field is an environment with light changing, the style transfer may be further performed on the images alternatively to generate more data of different styles for data augmentation. If the second field is an environment with stable light and low influence, or it is a controlled environment, the style transfer may not be performed for data augmentation. The image synthesis is performed by the image synthesis module 131. The image synthesis module 131 refers to the object position information obtained from the second field images by the object positioning module 112 to learn the position and distribution area where the objects will appear in the second field, and then synthesizes the new object images into the second field images based on the object position information.

The way of synthesis may randomly paste a large number of new object images of each group into reasonable positions where objects may appear in the second field images, and the same second field image may be synthesized with different new object image combination to generate new object field images based on the same second field image. For example, in the second field image originally including one object of Group A and one object of Group B, pasting one new object image of Group A and one new object image of Group B, the new object field image including two objects of Group A and two objects of Group B will be generated. The same second field image may also be pasted with one new object image of Group A and two new object images of Group B to generate another new object field image including two objects of Group A and three new objects of Group B. In addition, in one embodiment, it may also be pasted in by replacement. For example, in the second field image originally including one object of Group A and one object of Group B, pasting one object image of Group A on the object of Group B, the new object field image including two objects of Group A is generated. Here, the position of the object image included in the new object field image is the same as before pasting, but new image samples are obtained through replacement. In this way, even if the number of original second field images is limited, this random and diverse pasting or replacement method may be used to generate a large number of new object field images corresponding to the second field.

In addition, it is considered that if the second field is outdoors or a place where the lighting needs to be adjusted at any time, the data may also need to include data that correspond to different light tones. Therefore, shading and light tones of the new object field images may be further adjusted by the style transfer module 132 to augment data corresponding to different weather, morning and evening light, or lighting adjustments. The algorithm used in the style transfer may be, for example, Context-Aware Pyramid Vision Transformer Network (CAP-VSTNet), Style Shot-based Network (StyleShot), Adaptive Attention Network (AdaAttN), or Style Identity Network (StyleID). As long as it can be used for adjusting the image, the algorithm used in the style transfer is not limited thereto.

After image processing by the second image processing server 130, a large number of the new object field data corresponding to the second field, and the style-transferred new object field data adopted the style transfer are obtained as augmented data of the second field images, and used as the training data with the second field images, to train the object discrimination model by the object discrimination server 140. The object discrimination model may be any classification model or prediction model, and used for, for example, discriminating the grouping status of the target objects in the second field in real-time, or predicting upcoming events based on the second field after trained, and may be combined with an alarm system or an event analysis system. The object discrimination model may be, for example, Faster Region-based Convolutional Neural Network (Faster R-CNN), RetinaNet, You Only Look Once v4 (YOLOv4), You Only Look Once Version v7 (YOLOv7), or CenterNet, also known as Objects as Points. The object discrimination model is not limited thereto.

In addition, the new object images generated by the data augmentation server 120 may be stored in the image database 150. When there is a need to detect the same target object in a third field in the future, the new object images may be used as training data again for the object generation model to be trained to generate the new object images for the needs of the third field, or may be directly used to synthesize with the third field images if the objects are not very different. The new object field data and the style-transferred new object field data generated by the second image processing server 130 may also be stored in the image database 150, and be accessed at any time when the object discrimination server 140 has new model training needs corresponding to the second field subsequently.

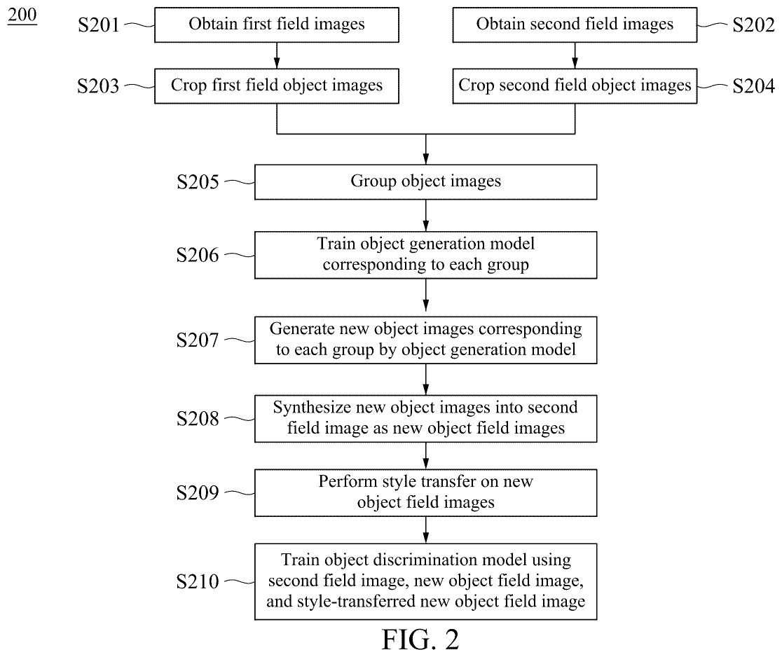

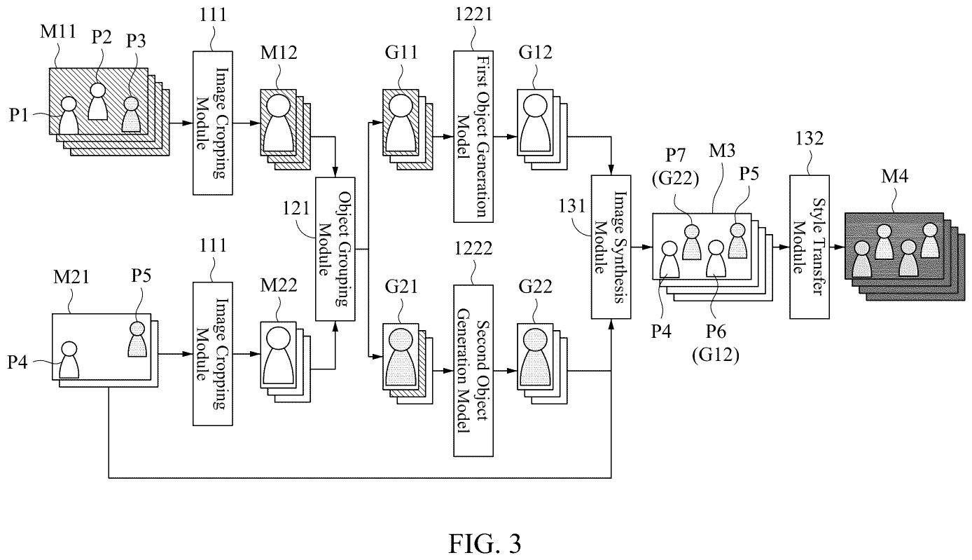

FIG. 2 is a flowchart of the data augmentation method 200 in accordance with some embodiments of the present disclosure. FIG. 3 is a schematic diagram of processing the images with the data augmentation method 200 in accordance with some embodiments of the present disclosure. According to FIG. 1 and FIG. 2, the detailed explanation of the data augmentation method 200 is described as following and taking the detection of the target object as workers with/without protective clothing as an example.

First, in Step S201 and S202, the first field images M11 and the second field images M21 are obtained from the image database 150. The number of the first field images M11 is greater than the second field images M21. The first field images M11 include objects P1-P3, and the second field images M21 include objects P4-P5, in which the objects P1, P2, and P4 represents the workers not wearing protective clothing, and the objects P3 and P5 represents the workers wearing protective clothing. Then, the image cropping module 111 performs Steps S203 and S204 to crop the first object images M12 and the second object images M22 corresponding to the objects P1-P3 and P4-P5 from the first field images M11 and the second field images M21 respectively.

Next, in Step S205, the first object images M12 and the second object images M22 are grouped by the object grouping module 121. In the embodiment, the grouping is according to whether the worker objects P1-P5 are wearing protective clothing in the first object images M12 and the second object images M22, and to group these images into a first group object images G11 corresponding to workers not wearing protective clothing and a second group object images G21 corresponding to workers wearing protective clothing. Then in Step S206, the object generation models corresponding to each group are trained by the object generation module 122, that is, the first group object images G11 are used for training the first object generation model 1221 in the object generation module 122, and the second group object images G21 are used for training the second object generation model 1222 in the object generation module 122, thereby establishing the first object generation model 1221 for generating images of workers not wearing protective clothing and the second object generation model 1222 for generating images of workers wearing protective clothing. In addition, if the casual clothes worn by workers who are not wearing protective clothing are too diverse or it is difficult to generate reasonable images, another object generation model may be established for the casual clothes.

After completing to establish the first object generation model 1221 and the second object generation model 1222, Step S207 is performed to generate the first new object images G12 and the second new object images G22 of each group with the first object generation model 1221 and the second object generation model 1222, that is, using these models to generate the first new object image G12 including the image of workers not wearing protective clothing, and the second new object images G22 including the image of workers wearing protective clothing.

At this stage, a large number of the new object images has been generated by the object generation model and may be stored in the image database 150 for subsequent new image synthesis, or the new object images may also be directly synthesized into the second field images as the new object field images by the image synthesis module 131 in Step S208. That is, in this embodiment, according to the object position information of the object P4-P5 obtained from the second field image M21 by the object positioning module 112, using the image synthesis module 131 to synthesize the first new object images G12 and the second new object images G22 into the second field image M21 as the new object field image M3. As shown in FIG. 3, in the new object field image M3, in addition to the objects P4 and P5 that were originally in the second field images M21, there are also a new object P6 added by pasting the first new object image G12 and a new object P7 added by pasting the second new object image G22. After pasting the first new object images G12 and the second new object images G22 into the second field image M21 with various synthesis combinations, new object field images M3 with a larger number than the original images may be obtained.

Since in the embodiment, the second field is outdoors, and there are images with light tone changes caused by weather and sunlight, Step S209 is performed, and the style transfer module 132 performs the style transfer on the new object field images M3, as the style-transferred new object field image M4 shown in FIG. 3. Finally, Step S210 is performed, in which the object discrimination model is trained with the second field images M21, the new object field images M3, and the style-transferred new object field images M4 by the object discrimination server 140.

In order to verify the effect of the data obtained by the data augmentation method 200 on object discrimination model training, an experiment is performed to compare the mean average precision (mAP) of the object discrimination model using object generation and style transfer to augment the data.

TABLE 1

| | | Number of | Number of | |
|---|---|---|---|---|
| Exper- | Number of | new object | style-transferred | Number |
| iment | second field | field | new object field | of total |
| No. | images M21 | images M3 | images M4 | images |
| 1 | 10,900 | 0 | 0 | 10,900 |
| 2 | 10,900 | 5,000 (by | 0 | 15,900 |
| | | crop-and-paste) | | |
| 3 | 10,900 | 5,000 (by | 5,000 | 20,900 |
| | | crop-and-paste) | | |
| 4 | 10,900 | 5,000 (by object | 0 | 15,900 |
| | | generation model) | | |
| 5 | 10,900 | 5,000 (by object | 5,000 | 20,900 |
| | | generation model) | | |
| 6 | 3,600 | 0 | 0 | 3,600 |
| 7 | 3,600 | 5,000 (by | 0 | 8,600 |
| | | crop-and-paste) | | |
| 8 | 3,600 | 5,000 (by | 5,000 | 13,600 |
| | | crop-and-paste) | | |
| 9 | 3,600 | 5,000 (by object | 0 | 8,600 |
| | | generation model) | | |
| 10 | 3,600 | 5,000 (by object | 5,000 | 13,600 |
| | | generation model) | | |

The experiment conditions are as shown in TABLE 1. In this experiment, the number of the first field images M11 is 115,000, and the number of the second field images M21 corresponding to two different fields are 10,900 and 3,600, respectively. The second field images M21 of the two different fields are respectively augmented with the data augmentation method 200 and used for training the object discrimination model. The new object field image M3 is generated by cropping out the objects P1-P5 in the first field images M11 and the second field images M21 and synthesizing them with the second field images M21, and by generating the first new object images G12 and the second new object images G22 by the object generation model and synthesizing them with the second field images M21, for a total of 5,000 new object field images M3 respectively. And it is divided into using and not using the style transfer to generate the style-transferred new object field images M4, and there are a total of 5,000 style-transferred new object field images M4.

TABLE 2

| Exper- | mAP(%) | | |
|---|---|---|---|
| iment | Wearing protective | No wearing protective | |
| No. | clothing | clothing | Average |
| 1 | 96.1 | 70.1 | 83.1 |
| 2 | 97.6 | 58.9 | 78.2 |
| 3 | 96.7 | 57.9 | 77.3 |
| 4 | 96.8 | 72.3 | 84.5 |
| 5 | 96.9 | 76.8 | 86.8 |
| 6 | 88.0 | 40.4 | 64.2 |
| 7 | 93.9 | 32.3 | 63.1 |
| 8 | 91.7 | 46.6 | 69.1 |
| 9 | 93.6 | 41.5 | 67.5 |
| 10 | 93.0 | 52.6 | 72.8 |

The experiment results are shown in TABLE 2. The mAP of the object discrimination model is improved with model training under the data augmentation method 200.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A data augmentation method, comprising:
obtaining first field images captured in a first field and second field images captured in a second field, wherein a number of the first field images is greater than a number of the second field images;
cropping first object images and second object images respectively from the first field images and the second field images;
training an object generation model with the first object images and the second object images;
generating new object images by the object generation model;
synthesizing the new object images into the second field images as new object field images; and
training an object discrimination model with the second field images and the new object field images.

2. The data augmentation method of claim 1, further comprising:
performing a style transfer on the new object field images into style-transferred new object field images;
training the object discrimination model with the second field images, the new object field image, and the style-transferred new object field images.

3. The data augmentation method of claim 1, further comprising:
grouping the first object image and the second object image into a plurality of groups;
training the object generation models corresponding to the plurality of groups with the first object images and the second object images; and
generating the new object images corresponding to the plurality of groups by the object generation models.

4. The data augmentation method of claim 1, further comprising:
obtaining object position information of the second object images in the second field images;
synthesizing the new object images into the second field images as new object field images based on the object position information.

5. The data augmentation method of claim 1, wherein the object generation model is trained with a text instruction, the first object images and the second object images.

6. The data augmentation method of claim 5, wherein the text instruction is generated by an image-to-text model with the first object images and the second object images.

7. The data augmentation method of claim 1, wherein synthesizing the new object images into the second field images is replacing or not replacing the second object images in the second field images with the new object images.

8. The data augmentation method of claim 1, further comprising:
synthesizing the new object images into third field images as the new object field images.

9. A data augmentation system, comprising:
an image database for storing first field images captured in a first field and second field images captured in a second field, wherein a number of the first field images is greater than a number of the second field images;
a first image processing server for receiving the first field images and the second field images from the image database, wherein the first image processing server comprises:
an image cropping module configured to crop first object images and second object images respectively from the first field images and the second field images;
a data augmentation server for receiving the first object images and the second object images from the first image processing server, and the data augmentation server comprises:
an object generation module configured to train an object generation model with the first object images and the second object images, and generating new object images by the object generation model;
a second image processing server for receiving the new object images from the data augmentation server, and the second image processing server comprises:
an image synthesis module configured to synthesize the new object images into the second field images as new object field images; and
an object discrimination server for training an object discrimination model with the second field images and the new object field images.

10. The data augmentation system of claim 9, wherein the second image processing server further comprises:
a style transfer module configured to perform a style transfer on the new object field images into style-transferred new object field images;
wherein the object discrimination server is for training the object discrimination model with the second field images, the new object field images, and the style-transferred new object field images.

11. The data augmentation system of claim 9, wherein the data augmentation server further comprises:
an object grouping module configured to group the first object images and the second object images into a plurality of groups;
wherein the object generation module is configured to train the object generation models corresponding to the plurality of groups with the first object images and the second object images and generate the new object images corresponding to the plurality of groups by the object generation models.

12. The data augmentation system of claim 9, wherein the first image processing server is further comprises:
an object positioning module configured to obtain object position information of the second object images in the second field images;
wherein the image synthesis module is further configured to synthesize the new object images into the second field images as new object field images based on the object position information.

13. The data augmentation system of claim 9, wherein the object generation model is trained with a text instruction, the first object images and the second object images.

14. The data augmentation system of claim 9, wherein synthesizing the new object images into the second field images the image synthesis module performed is replacing or not replacing the second object images in the second field images with the new object images.

15. The data augmentation system of claim 9, wherein the image synthesis module is further used for synthesizing the new object images into third field images as the new object field images.
